(19) United States
(12) Patent Application Publication
(10) Pub. No.: US 2021/0101441 A1
(43) Pub. Date: Apr. 8, 2021

(54) SYSTEM FOR PRESSURISING THE CABIN OF A VEHICULE OPERATING IN PARTICLE-LADEN AIR

(71) Applicant: ELIATIS, Moirans (FR)

(72) Inventor: Jean-Luc PERRIN, Voreppe (FR)

(73) Assignee: ELIATIS, Moirans (FR)

(21) Appl. No.: 16/605,061

(22) PCT Filed: Apr. 12, 2018
(86) PCT No.: PCT/FR2018/050916

§ 371 Date: Oct. 14, 2019

(30) Foreign Application Priority Data
Apr. 14, 2017 (FR) 1753301

(51) Int. Cl. B60H 1/00; B60H 3/06

(52) U.S. Cl. CPC B60H 1/00378; B60H 3/0608; B60H 1/008; B60H 1/00849; B60H 1/00742

(57) ABSTRACT

This system (1) includes an air intake (5) outside the cabin (2), a filter (8), and a turbine (10) for supplying pressurized air to the cabin (2). According to the invention: the air intake (5) is the one used to supply the engine of the vehicle with air; the system (1) includes an air intake duct (6) connected directly to the air delivery duct (7) extending between the air filter (8) of the engine of the vehicle and the engine or turbo compressor (9) with which the engine is equipped; and the turbine is a multi-stage turbine (10) which is capable of generating a depression greater than the maximum depression value likely to exist in the air delivery duct (7) depending on the clogged state of the air filter of the engine (8), the speed of the engine and the load on the engine.

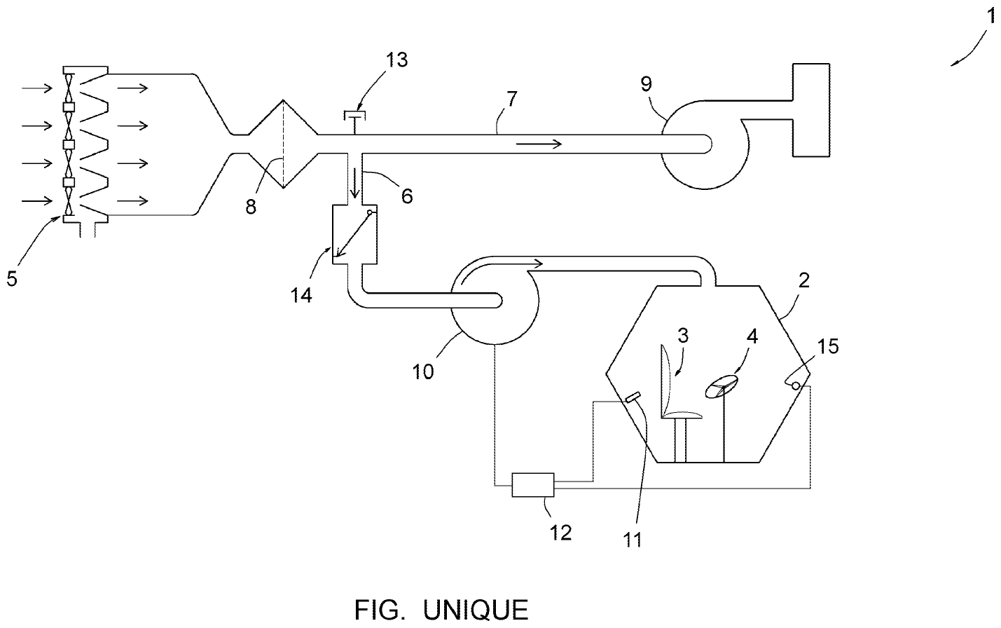

### CROSS REFERENCE TO RELATED APPLICATION

This application is a national stage entry of PCT/FR2018/050916 filed Apr. 12, 2018, under the International Convention and claiming priority over French Patent Application No. FR 1753301 filed Apr. 14, 2017.

### FIELD OF THE INVENTION

The invention relates to a pressurization system for the cabin of a vehicle operating in particle-laden air.

### BACKGROUND OF THE INVENTION

Some vehicles operate in an environment charged, or highly charged, with particles, such as forest bush-cutting vehicles, because the bush-cutting tool generates a considerable amount of plant particles, to which soil dust particles are added when the bush-cutting tool works near the ground. Other vehicles work in such environments, for example in mining, quarrying or public works.

The driver of the vehicle must of course be protected from these particles, and such vehicle is equipped with a pressurized cabin in which this driver sits, the pressurization, of the order of twenty Pascals, being sufficient to prevent the introduction of particles and other dust into the cabin.

On existing vehicles, the cabin pressurization system is an independent unit consisting of an air intake outside the cabin, a centrifugal cyclone operating a first removal of the particles, a filter operating a second particle removal and a turbine for supplying pressurized air to the cabin.

The disadvantage of this solution is that a dedicated filter exists on the vehicle, which must be periodically cleaned and replaced, which constitutes a significant operating constraint.

### OBJECTS OF THE INVENTION

The purpose of this invention is to remedy this essential practical disadvantage, without affecting the degree of pressurization of the cabin.

The patent application publications No. US 2005/121006 A1, KR 2003 0027265 A and US 2005/035209 A1 describe existing systems that do not achieve this objective.

### SUMMARY OF THE INVENTION

The system concerned comprises, in a manner known per se, an outside air intake, an engine air filter, and a turbine for supplying pressurized air to the cabin.

According to the invention,

the air intake is the one used to supply the engine of the vehicle with air;

the system comprises an air intake duct connected directly to the air delivery duct extending between the air filter of the engine of the vehicle and the engine or turbo compressor with which the engine is equipped; and

the turbine is a multi-stage turbine capable of generating a depression greater than the maximum depression value that may exist in said air delivery duct depending on the state of clogging of the air filter of the engine, the speed of this engine and the load on this engine.

The inventor conceived the interest of taking the air supplied to the cabin from the air delivery duct connecting the air filter of the engine to the turbo compressor of this engine, since this make it possible to take advantage of this air filter and make it unnecessary to provide a dedicated air filter for the cabin air pressure system, and therefore make it possible to avoid having to maintain this filter; another advantage of this design is to benefit in addition from the centrifugal multi-cyclone system acting upstream of this air filter in order to carry out a first purification of the air captured by the engine air intake. The inventor then realized the existence of the difficulty in implementing such a system, resulting from the large variation in the depression existing in the said air delivery duct as a function of the clogged state of the air filter of the engine, of the variations in the speed of this engine and of the load to which this engine is subjected. The inventor then conceived that a multi-stage turbine should be used to supply the cabin with air, capable of generating a depression always greater than the said maximum depression value likely to exist in the said air delivery duct depending on the operating conditions of the engine mentioned above.

The inventor was able to determine the said maximum depression value as being in the order of about 600 mm water column, and that it was therefore necessary, in order to adequately pressurize the cabin, that the turbine be able to generate an air depression greater than 600 mm water column. In practice, this turbine must be able to generate a depression between 650 mm of water column and about 1100 to 1200 mm of water column.

The turbine used in accordance with the invention is the one sold by the US company AMETEK (in Kent, Ohio), under the reference 116157-29.

According to a simple embodiment of the invention, the turbine is of a type of turbine rotating at a fixed speed, for example 1500 rpm, during its use.

The inventor was able to determine that the pressure in the cabin actually varied very little despite the large variation in the depression in the air duct, which made it possible to use a turbine of this type.

According to a preferred embodiment of the invention, the turbine is of a type of turbine rotating at a variable speed during its use, and the system comprises:

a differential pressure sensor present in the cabin; and

a computer connected to this sensor on the one hand and to the turbine on the other hand, acting on the rotational speed of the turbine based on the pressure detected by the sensor in the cabin, this speed being increased in the event that the sensor detects a pressure drop in the cabin with respect to the value set by the sensor and stored as a set value in the computer, and being reduced in the event that the sensor detects an increase in this pressure in the cabin with respect to this same set value.

A differential pressure sensor is defined as a sensor including two pressure sensing probes, one in the cabin of the vehicle and the other outside the cabin; this outside probe captures the ambient atmospheric pressure and indicates the difference between this atmospheric pressure value and the current pressure value in the cabin of the vehicle. This type of sensor allows the variation in atmospheric pressure to be taken into account; the computer, to which the said difference is transmitted, takes this difference into account to adapt the cabin pressurization so that it is effective regardless of atmospheric pressure. Such a differential pressure sensor has the advantage of not requiring calibration, thus making it possible to adapt the overpressure value that should exist in the cabin to this atmospheric pressure; this overpressure value can be equal to the atmospheric pressure increased from 20 to 35 Pa.

In another preferred embodiment, the turbine is also of a type of turbine rotating at a variable speed during its use, and the system comprises:

a pressure sensor present in said air delivery duct; and

a computer connected to this sensor on the one hand and to the turbine on the other hand, acting on the rotational speed of the turbine based on the pressure detected by the sensor in the air delivery duct, this speed being increased in the event that the sensor detects a pressure drop in this duct with respect to the set value stored in the computer, and being reduced in the event that the sensor detects an increase in this pressure in the duct with respect to the same set value.

Preferably, the pressurization system comprises a sensor detecting when said maximum depression value is reached in said air delivery duct, and triggering an alarm if this value is reached.

The driver of the vehicle is thus alerted when the said value is reached, which value corresponds to an upper limit of acceptable clogging of the engine's air filter.

In the case of the above-mentioned preferred embodiments, and when the system comprises this maximum depression threshold sensor in said air supply duct, the system comprises a check valve between said air supply duct and the turbine, closing when the air circulation is not in the filter-to-cabin direction. It prevents the risk of the cabin being depressed if the air filter is clogged, and also the risk of polluting, and therefore damaging, the internal combustion engine by drawing unfiltered air from the cabin.

In either of the above-mentioned simple and preferred embodiments, the system according to the invention may comprise a sensor for sensing the opening or the closing of the door of the cabin, connected to the computer, allowing the turbine to be activated only if the door is closed.

The invention shall be well understood, and other characteristics and advantages of the invention shall appear, with reference to the attached drawing, representing, by way of example, a preferred embodiment of the system it concerns.

### BRIEF DESCRIPTION OF THE FIGURES

The single FIGURE is a very schematic and simplified view of the system according to the present invention.

### DETAILED DESCRIPTION OF THE INVENTION

The single FIGURE is a very schematic and simplified view of this system, which is a system 1 for pressurizing cabin 2 of a vehicle operating in particule-laden air, this cabin 2 containing a seat 3 and steering components 4 of the engine.

The system 1 comprises:

an external air intake 5, which is the one used to supply the engine of the vehicle with air;

an air intake duct 6 connected directly to the air delivery duct 7 extending between the air filter 8 of the engine of the vehicle and the turbo compressor 9 with which this engine is equipped; and

a multistage 10 turbine with variable rotation speed, capable of generating a depression between 650 mm water column and about 1100 to 1200 mm water column; this turbine is notably the one sold by the US company AMETEK (in Kent, Ohio), under the reference 116157-29;

a differential pressure sensor 11, present in the cabin 2;

a computer 12 connected to this sensor 11 on the one hand and to the turbine 10 on the other hand;

a sensor 13, detecting when a maximum depression value is reached in air duct 7, and triggering an alarm (not shown, present in cabin 2) when this value is reached;

a check valve 14 present between said air delivery duct 7 and turbine 10 closing so as to prevent the air flow from being reversed; and

a sensor 15 for opening or closing the door of cabin 2, connected to the computer 12, allowing the activation of turbine 10 to be controlled only if this door is closed.

In practice, turbine 10 transports the captured air in duct 7 to cabin 2 at a pressure that puts the cabin in overpressure, at a level in the order of 20 to 35 Pascals above atmospheric pressure. The differential pressure sensor 11 comprises two pressure detection probes, one in cabin 2 and the other outside this cabin; this outside probe detects the ambient atmospheric pressure and therefore adapts the overpressure value that should exist in cabin 2 according to this atmospheric pressure. This overpressure value is transmitted to computer 12, which acts on the rotational speed of turbine 10 as a function of the pressure detected in cabin 2, this speed being increased when a pressure drop in the cabin is detected in relation to the pressure value established by means of sensor 11 and stored as a set value in computer 12, and reduced when an increase in this pressure in cabin 2 is detected in relation to this same set value.

The maximum depression value that may exist in air duct 7 is a function of the clogged state of the air filter 8, the current engine speed and the current load to which this engine is subjected; reaching this value is detected by sensor 13, which triggers the alarm to the driver, and closes the check-valve 14; this closure eliminates any risk of depression in the cabin 2 through turbine 10 until this turbine is activated so as to over-pressurize cabin 2 again.

The invention thus provides a pressurization system for the cabin of a vehicle operating in an air charged with particles, making it possible to take advantage of the air filter of the engine and make it unnecessary to provide a dedicated air filter for the cabin air pressurization system, and thus to free oneself from having to maintain this filter.

The invention has been described above with reference to an embodiment provided as an example; it goes without saying that the invention is not limited to that embodiment but extends to all embodiment covered by the appended claims.

1. A pressurization system for pressurizing a cabin of a vehicle operating in particle-laden air, comprising:
an air intake outside the cabin;
an engine air filter; and
a turbine for supplying pressurized air into the cabin,
wherein:
the air intake supplies the vehicle engine with air;
the system further includes an air intake duct connected directly to an air delivery duct extending between the engine air filter and an engine or a turbo compressor located on the engine; and
the turbine is a multi-stage turbine for generating a depression greater than a maximum depression value that exist in said air delivery duct depending on the state of clogging of the engine air filter, a speed of the engine, and a load on the engine.

2. The pressurization system according to claim 1, wherein said maximum depression value is about 600 mm water column and the turbine generates an air depression of more than 600 mm water column.

3. The pressurization system according to claim 2, wherein the turbine generates an air depression between 650 mm of water column and about 1100 to 1200 mm of water column.

4. The pressurization system according to claim 3, wherein the turbine is an AMETEK turbine.

5. The pressurization system according to claim 1, wherein the turbine is a rotating turbine at a fixed speed.

6. The pressurization system according to claim 1, wherein the turbine is a rotating turbine at a variable speed and the system; comprises:
a differential pressure sensor located in the cabin; and
a computer connected to the differential pressure sensor on one side and to the turbine on the other side, acting on the rotational speed of the turbine based on the pressure detected by the differential pressure sensor in the cabin, the speed being increased in the event that the differential pressure sensor detects a pressure drop in the cabin with respect to the value set by the differential pressure sensor and stored as a set value in the computer, and being reduced in the event that the differential pressure sensor detects an increase in the pressure in the cabin with respect to the same set value.

7. The pressurization system according to claim 1, wherein turbine is a turbine at a variable speed, and the system comprises:
a pressure sensor located in said air delivery duct; and
a computer connected to the pressure sensor on one side and to the turbine on the other side, acting on the rotational speed of the turbine based on the pressure detected by the pressure sensor in the air delivery duct, the speed being increased in the event that the pressure sensor detects a pressure drop in the duct with respect to the set value stored in the computer, and being reduced in the event that the pressure sensor detects an increase in the pressure in the duct with respect to the same set value.

8. The pressurization system according to claim 1, wherein further includes a sensor for detecting when said maximum depression value is reached in said air delivery duct, and triggering an alarm if the value is reached.

9. The pressurization system according to claim 6, further comprising a check valve located between said air delivery duct and the turbine, the check valve is adjusted so as to close when said maximum depression value is reached in the duct.

10. The pressurization system according to claim 1, further including a sensor for sensing the opening or the closing of a door of the cabin, connected to the computer, allowing the turbine to be activated only if the door is closed.
